(19) United States
(12) Patent Application Publication
(10) Pub. No.: US 2015/0149020 A1
(43) Pub. Date: May 28, 2015

(54) METHOD AND APPARATUS FOR MONITORING USE OF MOBILE COMMUNICATIONS IN A VEHICLE

(71) Applicant: Willis Dean Smith, Plano, TX (US)

(72) Inventor: Willis Dean Smith, Plano, TX (US)

(21) Appl. No.: 14/088,245

(22) Filed: Nov. 22, 2013

(51) Int. Cl. B60W 40/09; G07C 5/00

(52) U.S. Cl. CPC B60W 40/09; G07C 5/00
USPC 701/23; 701/1

(57) ABSTRACT

A system and method for analyzing a driving pattern. A vehicle sensor monitor may be configured to receive information related to a vehicle driving system. A detector module may be configured to detect activity from a mobile device used while in a vehicle, wherein the information comprises mobile information while the mobile device is in use and non-mobile information while the mobile device is not in. A variance analysis module may be configured to correlate the activity with the mobile information to form a mobile driving pattern.

### TECHNICAL FIELD

This disclosure is generally directed to monitoring systems operable in a moving vehicle, and more particularly to monitoring use of personal electronic devices in a moving vehicle.

### BACKGROUND

It takes about one second for a driver to recognize a danger and physically react to it. Because of this lengthy reaction time, any driver distraction can be a major contributor to vehicular accidents. Frequently, a driver is trying to perform two or more tasks at the same time, which has been proven to be difficult for nearly everyone. Therefore, vehicle manufacturers have used human factors engineering to design systems which facilitate performing certain tasks when driving. However, these designs do not address the fact that people are especially incapable of performing simultaneous tasks involving complex thinking, such as dealing with a sudden change in traffic while analyzing information and making decisions.

In recent years, mobile communications devices have become omnipresent in vehicles. Their usage frequently requires both device manipulation and complex thinking that increase the risk of accidents except when the vehicle is parked out of traffic. Dealing with texts and other messaging systems are very distracting to drivers. Even if the driver's eyes are nominally on the road, the driver may not be perceiving events properly because of being mentally preoccupied. It is important to convince drivers that the use of mobile communication devices in their vehicle is degrading their operation of the vehicle. Passenger use of these devices can also affect driver function if information being received is then sent or shared.

Currently, there is no system that evaluates driver performance when a vehicle is in operation and a mobile communication device or devices is being used in the vehicle either by the driver or by one or more passengers.

### SUMMARY

Embodiments of this disclosure include a system and method for analyzing a driving pattern. A vehicle sensor monitor may be configured to receive information related to a vehicle driving system. A detector module may be configured to detect activity from a mobile device used while in a vehicle, wherein the information comprises mobile information while the mobile device is in use and non-mobile information while the mobile device is not in use. A variance analysis module may be configured to correlate the activity with the mobile information to form a mobile driving pattern.

### BRIEF DESCRIPTION OF THE DRAWINGS

For a more complete understanding of this disclosure and its features, reference is now made to the following description, taken in conjunction with the accompanying drawings, in which:

FIG. 1 illustrates a schematic diagram of a monitoring environment 10 in accordance with an embodiment;

FIG. 2 illustrates a schematic diagram of a monitoring environment 23 in accordance with an embodiment;

FIG. 3 illustrates a schematic diagram of a monitoring environment 25 in accordance with an embodiment;

FIG. 4 illustrates a schematic diagram of a monitoring environment 27 in accordance with an embodiment;

FIG. 5 illustrates a flowchart for finding historic driving patterns in accordance with an illustrative embodiment;

FIG. 6 illustrates a flowchart for finding mobile driving patterns in accordance with an illustrative embodiment

FIG. 7 illustrates a flowchart for finding a variance in driving pattern in accordance with an illustrative embodiment;

FIG. 8 illustrates a flowchart for analyzing a driving pattern in accordance with an illustrative embodiment; and

FIG. 9 is an embodiment of a general purpose computer 910 in accordance with an illustrative embodiment.

### DETAILED DESCRIPTION

The FIGURES discussed below, and the various embodiments used to describe the principles in this disclosure are by way of illustration only and should not be construed in any way to limit the scope of the embodiments. Those skilled in the art will understand that the principles of the embodiments in this disclosure may be implemented in any suitable manner and in any type of suitably arranged device or system.

This disclosure embodies a range of system capabilities and data analysis methodologies depending on the level of knowledge that the customer needs. Herein are described embodiments to monitor and assess the usage of mobile communication devices in vehicles during operation. One embodiment monitors usage of mobile communication devices (MCDs) in vehicles and transmits data electromagnetically to a central monitoring station. Another embodiment involves systems and methodologies to assess the driver's behavior over different periods of time to establish a variance in driver performance when mobile communication devices are being utilized in the vehicle in comparison to when they are not. Each embodiment has various features depending on the complexity of the devices and systems being employed and the data analysis methodology.

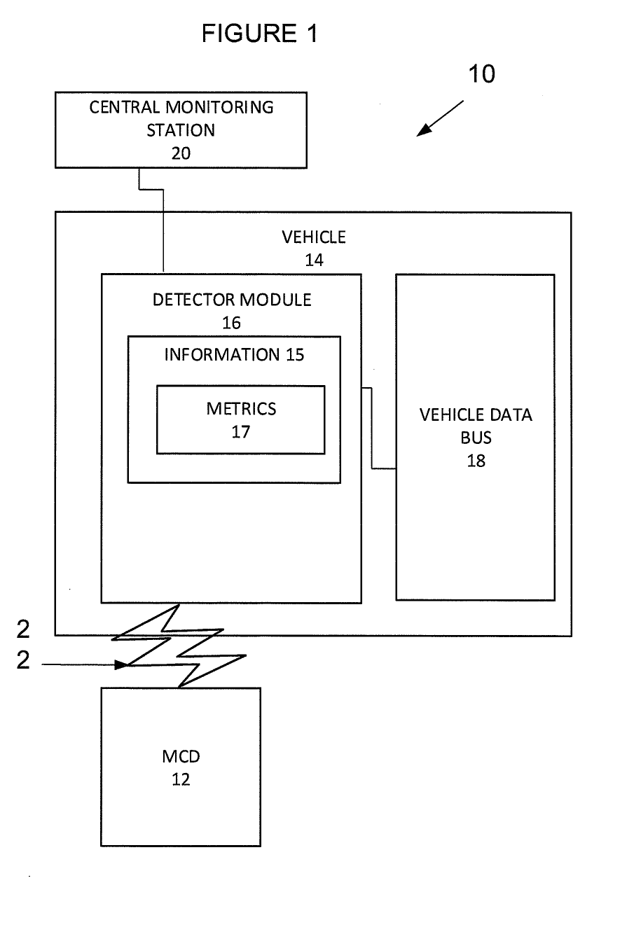

FIG. 1 illustrates a schematic diagram of a monitoring environment 10 in accordance with an embodiment. In one or more embodiments, monitoring environment 10 may include a mobile communication device (MCD) 12, a vehicle 14 with a detector module 16 and vehicle data bus 18, and a central monitoring station 20.

In an embodiment, detector module 16 may monitor an activity 22 of mobile communication device 12. MCD 12 may be, for example, satellite communicators, citizens band, and other radios, a cellular communication device, a personal device accessory, a personal computer, a Tablet PC, and/or a device with wireless communication capabilities. MCD 12 may be hand-held, mounted-on, or built into vehicle 14. Based on a customer's (also referred to as user) needs, detector module 16 may be capable of logging activity 22 in all cell phones modes, including standby, texts, WiFi, data and calls, with all available protocols. In other embodiments, detector module 16 may also log usage, communications, data, and/or the like. In different embodiments, detector module 16 may also be referred to as MCD detector and/or electronic detector.

In an embodiment, activity 22 may be uplink and/or downlink communications for the use of networks (e.g., Wi-Fi, WiMax, Internet, cellular) and network services (e.g., map services, web services, syncing services). Detector module 16 may monitor activity 22 of MCD 12, the type of activity, the actual data packets, the usage, and/or the like. For example, detector module 16 may monitor the amount of time, the network used, the network service, or a combination of MCD 12.

In an embodiment, a detection range for monitoring activity of MCD 12 is adjustable to limit the monitoring of device(s) to the immediate interior and/or vicinity of vehicle 14. For example, the detection range may be adjusted to a certain radial distance, projected to an area, linked with a specific MCD, or the like. Similarly, the detector module 16 may be able to log all activity of other communication devices and modes in vehicle 14. In an embodiment, detector module 16 intercepts all signals (i.e., communications or activity) from one, some, or all of the MCDs in the detection range. Additionally, detector module 16 is capable of monitoring activity of wireless devices, such as Bluetooth devices, near field communication devices, cellular, Wi-Fi, or the like, for mounted or built-in MCDs.

Detector module 16 may derive power from the electrical system of vehicle 14, such as through outlets or vehicle data bus 18, so that detector module 16 may operate while vehicle 14 is operating. In one embodiment, persistent, longer-term activity 22 of MCD 12 is of interest. In other embodiments, short-term activity 22 may be of interest. In further embodiments, a combination of short-term and long-term may be of interest. Detector module 16 may have a communication link configured to communicate with a receiver associated with remote central monitoring station 20.

In one or more embodiments, detector module 16 may have various additional capabilities configured to monitor metrics 17 on information 15 include activity 22. In some embodiments, the metrics may be analyzed on their own. In other embodiments, the metrics may be analyzed in combination with behavior patterns of a driver. The metrics may be used by a driver in exchange for benefits received such as lower insurance rates or use of vehicle 14. The monitored metrics from detector module 16 can be used in multiple ways depending on the complexity of the system in which detector module 16 is employed.

For example, detector module 16 may be configured to establish a unique identification code for each of the mobile communication devices in use. This identification code permits identifying the most frequently used mobile communication device in the vehicle. In one embodiment, the most used MCD may be the MCD used by the driver. In other embodiments, the most used MCD may not be the MCD in use by the driver. In another example, the identification code (ID) may be used to separate activity 22 coming from different MCDs, allowing metrics to be analyzed for each MCD separately.

In another example, the information including metrics and/or driver behavior patterns may be transmitted to central monitoring station 20. For example, the frequency and length of time MCD 12 is used along with location and time data from a Global Positioning System (GPS) or comparable systems in vehicle 14 can be transmitted to central monitoring station 20. The GPS or comparable devices can be incorporated into detector module 16 or, if available on-board the vehicle 14, supply data to detector module 16.

This combined data, when processed into information 15, may be sufficient for an insurance company to lower rates for those who are determined to minimize use of such devices during operation of vehicle 14. An independent monitoring service, such as On-star, might indicate to an owner of vehicle 14 that excessive use of such devices is regularly occurring to help train inexperienced or problematic drivers. For example, if detector module 16 shows information 15 that has metrics 17 that indicate the driver rarely uses MCD 12 while driving, an insurance company may give a price break. However, if the opposite is true, and the driver uses MCD 12 frequently while driving, then insurance company may increase the driver's premiums.

Alternatively, such a service might convey to the driver that the frequency of use of the communication devices seems problematic by whatever criteria the service devises. Detector module 16 may be configured to aid in determining when, where, and by whom mobile communication devices are being used. For instance, monitoring airbag deployment sensors for occupied seats may tell when the driver was alone in the vehicle. In another example, a video camera system with infrared capability may monitor which user is operating an MCD.

Data processing at central monitoring station 20 for the system may be configured to determine the driver usage with time and place of mobile communication devices for the customer paying for the system and service. In different embodiments, central monitoring station 20 may include a central monitoring module. The central monitoring module may perform the processes, methods, and functions described as being operating by central monitoring station 20. In different embodiments, central monitoring station 20 may be a remote location, in other embodiments, central monitoring station 20 may be located in vehicle 14.

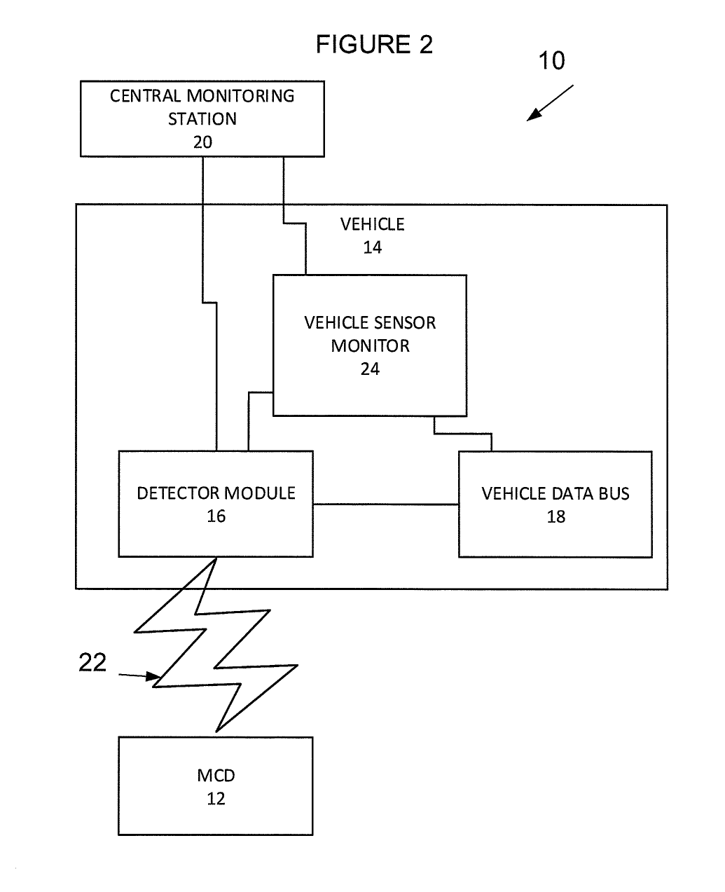

FIG. 2 illustrates a schematic diagram of a monitoring environment 23 in accordance with an embodiment. In one or more embodiments, monitoring environment 23 may include mobile communication device (MCD) 12, vehicle 14 with detector module 16, vehicle data bus 18 and vehicle sensor monitor 24, and central monitoring station 20.

In an embodiment, monitoring environment 23 may be similar to monitoring environment 10, however monitoring environment 23 has vehicle sensor monitor 24 in vehicle 14. Vehicle sensor monitor 24 may monitor the different systems of vehicle 14. For example, vehicle sensor monitor 24 may monitor air bag deployment, air bag on/off indicators, breaking frequency and speed, speed and acceleration of the vehicle, speed of the vehicle compared to speed limits using GPS

In an embodiment, detector module 16 may possess most or all the features described above in FIG. 1 in conjunction with vehicle system monitor 24 that may monitor other information about the operational parameters of vehicle 14. In an embodiment, vehicle system monitor 24 may communicate some of this information to central monitoring station 20 that is a form of telematics and/or may record information on-board vehicle 14.

In an embodiment, detector module 16 and vehicle sensor monitor may separately communicate with central monitoring station 20. In some examples, if vehicle sensor monitor is factory-installed it may be difficult to couple the detector module 16. In other examples, if detector module 16 can be coupled with vehicle sensor monitor 24, then they may communicate to central monitoring station together or may still communicate separately.

In this embodiment, detector module 16 may be capable of learning an ID of the any telematics device in vehicle 14 in order to ignore its communications to central monitoring station 20. With a telematics system or device with an open architecture, detector module 16 could be connected with a cable for joint communication to central monitoring station 20.

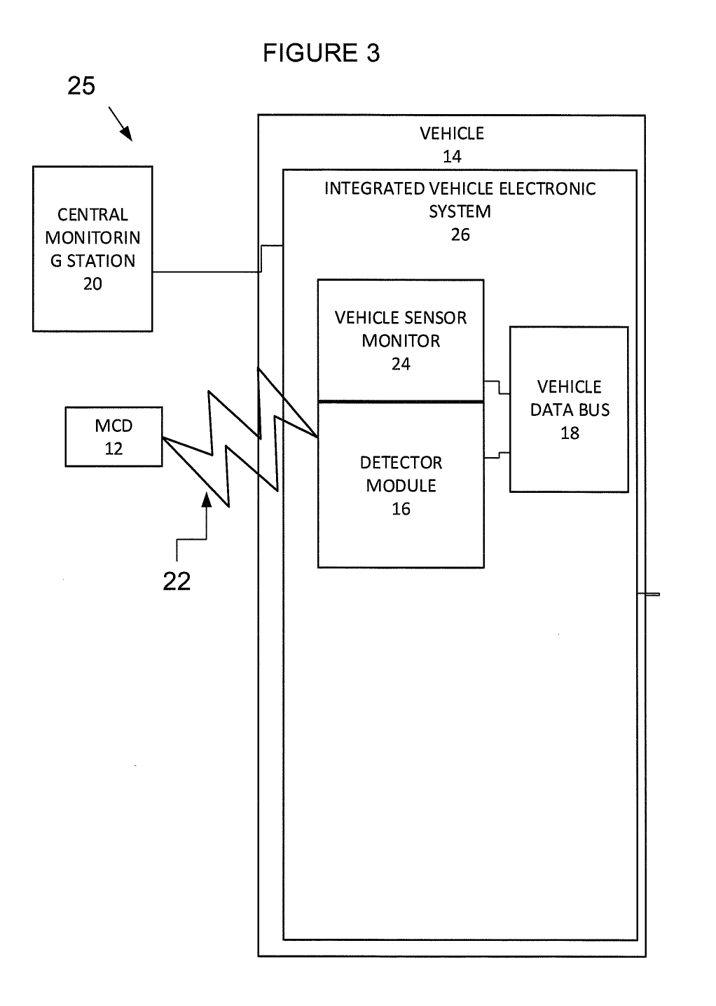

FIG. 3 illustrates a schematic diagram of a monitoring environment 25 in accordance with an embodiment. In one or more embodiments, monitoring environment 25 may include mobile communication device (MCD) 12, vehicle 14 with an integrated vehicle electronic system 26, and central monitoring station 20.

In an embodiment, monitoring environment 25 may be similar to monitoring environments 10 and 23, however monitoring environment 25 has integrated vehicle electronic system 26 in vehicle 14. Integrated vehicle electronic system 26 may include a combination of detector module 16 and vehicle sensor monitor 24.

In an embodiment, detector module 16 may be built-in or coupled with vehicle sensor monitor 24. Detector module 16 and associated analysis methodology may be connected with telematics systems that are built into integrated vehicle electronics system 26. Sophisticated telematics systems are being installed by the vehicle manufacturers including additional sensors to monitor additional aspects of the vehicle's performance and operation. Detector module 16 along with circuitry to transmit data from vehicle data bus 18 can be integrated by the vehicle manufacturer.

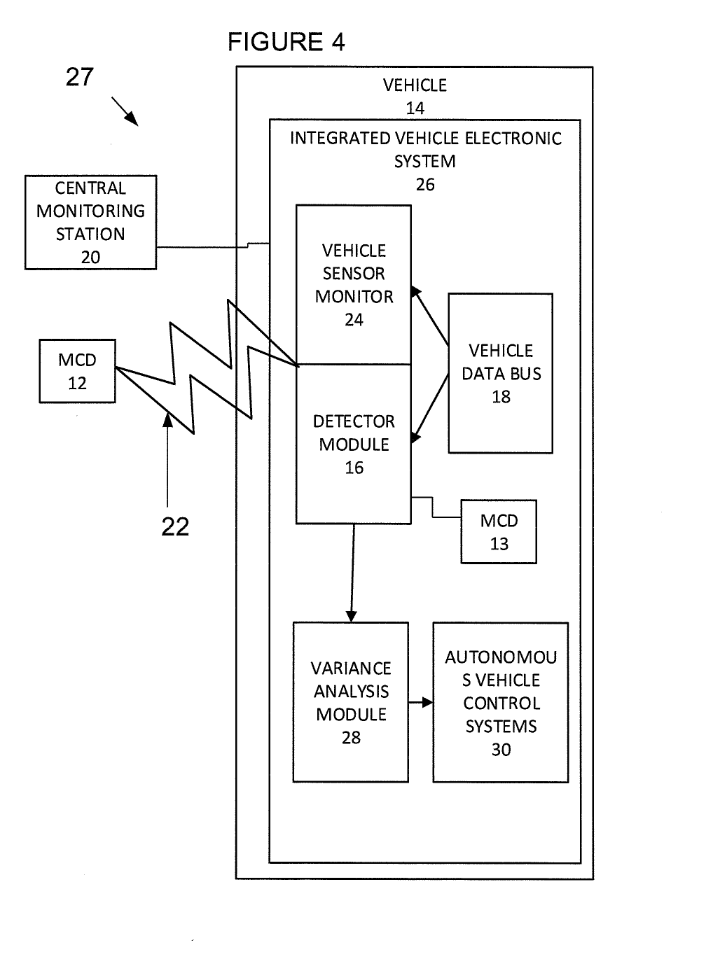

FIG. 4 illustrates a schematic diagram of a monitoring environment 27 in accordance with an embodiment. In one or more embodiments, monitoring environment 27 may include mobile communication device (MCD) 12, vehicle 14 with integrated vehicle electronic system 26, and central monitoring station 20.

In an embodiment, monitoring environment 27 may be similar to monitoring environments 10, 23, and 25, however monitoring environment 27 has a variance analysis module 28 and an autonomous vehicle control system 30 as part of integrated vehicle electronic system 26 in vehicle 14. Monitoring environment 27 may also include a video camera system with infrared capability monitoring driver eye behavior. Variance analysis module 28 may be configured to compare and correlate metrics 17 from vehicle sensor monitor 24 and detector module 16. Autonomous vehicle control system 30 may be configured to control driving systems in vehicle 14 in response to the results of variance analysis module 28 and/or information 15 from detector module 16 and vehicle sensor monitor 24.

In an embodiment, on-board or off-board analysis can be performed to assess the driver's behavior with and without the usage of MCD 12. MCD 12 and/or other types of MCDs, such as Bluetooth devices, may be built into the vehicle or supplied by the driver and passengers. The list of monitored behaviors may include but not limited to such things as braking sharply, changing speeds, driving too fast or too slow, ignoring traffic signs (as indicated by location and time data), wandering in the lane, using turn signals, accelerating rapidly, riding the brake, following too closely, etc. The list of monitored behaviors may also include changes in driver eye behavior including blink rates, pupil size and eye ball movement. Driving conditions, such as weather, construction and blockages, can be included in the analysis. There are sufficient sources of data to use data mining software to establish a characteristic historical baseline of driver behavior in time periods and places when mobile communication devices are not being used. This historical baseline may be referred to as a historic behavior pattern.

The value of this electronic detection system comes into play when these same parameters are evaluated during use of MCD 12 or other MCDs, such as built-in MCD 13. A subset of the available parameters may be sufficient to assess driver distraction. In an example embodiment, each of the parameters can be continuously assessed against the historic behavior pattern, including location coordinates and time of day, for changes during these usages. The changes in the individual parameters can also be assessed, individual and/or together, in order to measure driver distraction during these intervals.

This correlation analysis may provide indications of the degree of distraction caused by each communication mode, such as making phone calls, texting, tweeting, and any other messaging methods at comparable locations and times by visual and tactile interaction with MCD 12. Additionally, the correlation will also determine the distraction from voice translation features rather than visible and manual interactions for using mobile communication devices. For instance, a driver who regularly texts at stoplights, misses the light turning green and then accelerates rapidly to keep up with traffic may be identified.

The analysis can be performed on-board and transmitted to central monitoring station 20 or information 15 can be transmitted to central monitoring station 20 for analysis depending on the system design and the desires of the users of the analysis. Alternatively, the on-board analysis can be used to activate or enhance autonomous vehicle control systems 30, such as lane control or collision avoidance, when the driver's behavior changes due to distraction from MCD 12 or from interactions with other devices or people in the vehicle. In one embodiment, the variance analysis module through the vehicle system or a central processing center could alert the driver that the communications activity seems to be affecting the driver's performance and caution against continued use. This is a method to monitor the extent of mental distraction of the driver due to mental involvement with the communication activities.

Current systems may detect some variations in driver's behavior, but they do not provide insight into why the variance happens. They do not provide insights of driver activities when the vehicle is stopped in traffic. The embodiments of this disclosure provide data to which MCDs are causing variances in driver behavior. In FIGS. 1-4, it is shown that central monitoring station is associated with an element within vehicle 14. This association may be a connection by a wired or wireless network. The network may include other components between central monitoring station 20 and vehicle 14 that are not shown.

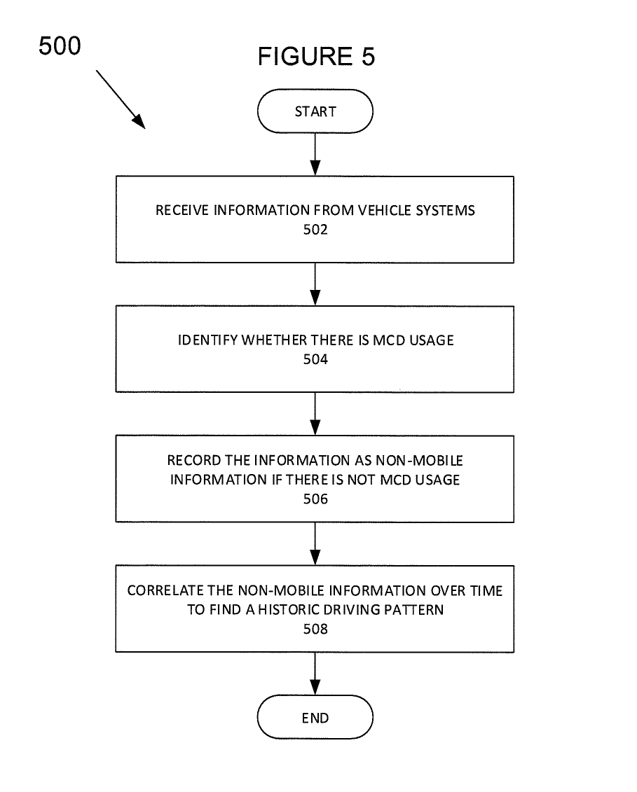

FIG. 5 illustrates a flowchart for finding historic driving patterns in accordance with an illustrative embodiment. Process 500 may be executed in combination with devices and elements illustrated in this disclosure. In an embodiment, a vehicle sensor monitor receives information from vehicle systems (step 502). The information may be from an integrated system with the vehicle. The vehicle systems may be driving systems, GPS systems, or the like. The information may include braking frequency and speed, changing speeds, driving speeds, wandering in the lane, using turn signals, accelerating rapidly, riding the brake, following too closely, driving conditions, such as weather, construction and blockages, can be included in the information.

Next, a detector module may identify if there is MCD usage (step 504). If there is not MCD usage, the variance analysis module may record the information as non-mobile information (step 506).

Next, a central monitoring station, which may be in one embodiment, but not limited to, an on-board central monitoring module, may correlate the non-mobile information received over time to find a historic driving pattern (step 508). The central monitoring station may use data mining software. Also, the historic driving pattern may be a function of place and time.

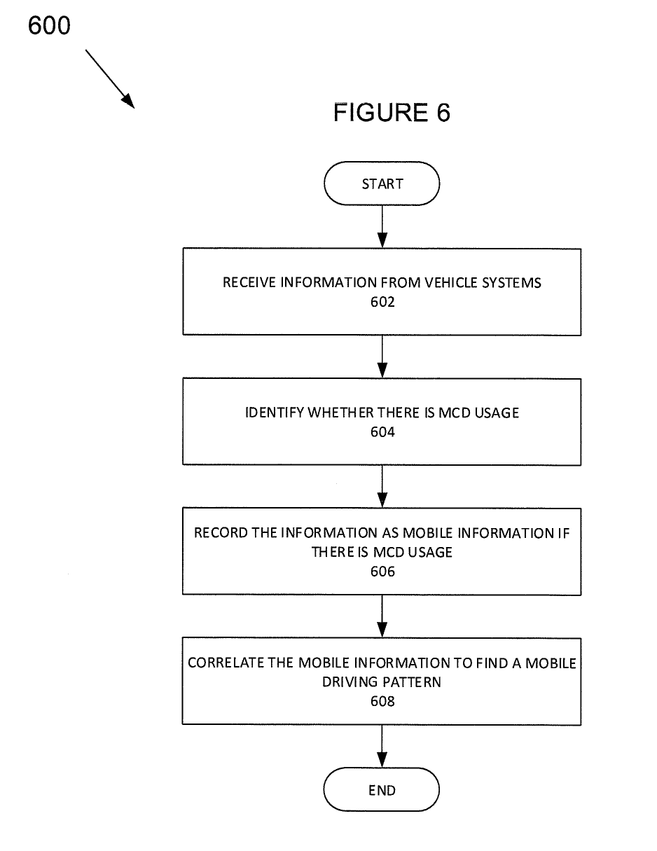

FIG. 6 illustrates a flowchart for finding mobile driving patterns in accordance with an illustrative embodiment. Process 600 may be executed in combination with devices and elements illustrated in this disclosure. In an embodiment, a vehicle sensor monitor receives information from vehicle systems (step 602). The information may be from an integrated system with the vehicle. The vehicle systems may be driving systems, GPS systems, or the like. The information may include braking frequency and speed, changing speeds, driving speeds, wandering in the lane, using turn signals, accelerating rapidly, riding the brake, following too closely, driving conditions, such as weather, construction and blockages and driver eye behavior.

Next, a detector module may determine if there is MCD usage (step 604). If there is MCD usage, a variance analysis module may record information received at mobile information (step 606). Next, the mobile information may be used to find a mobile driving pattern (step 608).

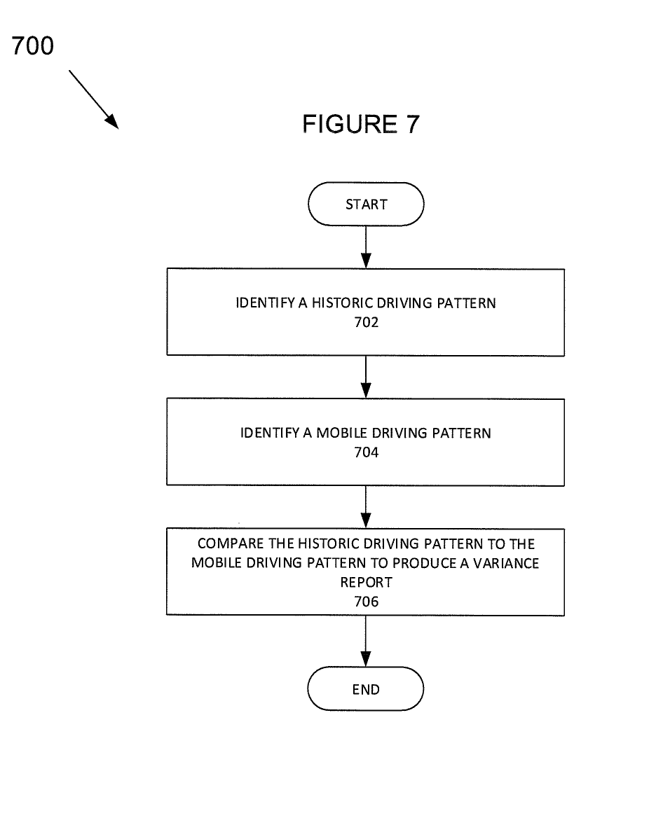

FIG. 7 illustrates a flowchart for finding a variance in driving pattern in accordance with an illustrative embodiment. Process 700 may be executed in combination with devices and elements illustrated in this disclosure. Process 700 may be used to identify a correlation between a historic behavior pattern of driving without the use of an MCD and a mobile driving pattern with the use of an MCD.

First, an apparatus identifies a historic driving pattern (step 702). Next, the apparatus receives a mobile driving pattern (step 704). Steps 702 and 704 may be performed at the same time, or in any order. Next, the apparatus compares the historic driving pattern to the mobile driving pattern to produce a variance report (step 706). The variance report may indicate a drivers loss of driving ability while using a mobile device. Companies, such as insurance companies, may use the variance report to adjust premiums for car insurance.

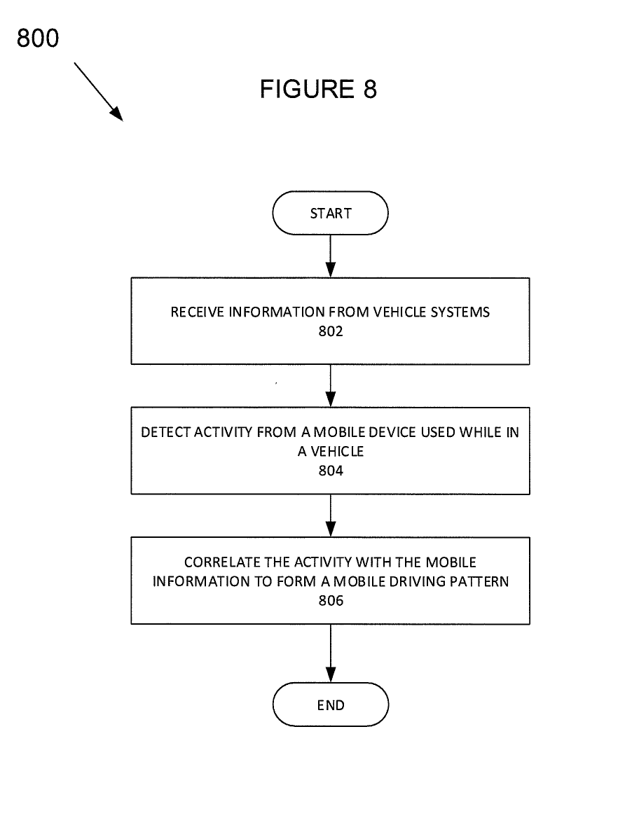

FIG. 8 illustrates a flowchart for analyzing a driving pattern in accordance with an illustrative embodiment. Process 800 may be executed in combination with devices and elements illustrated in this disclosure.

First, a vehicle sensor monitor may receive information related to a vehicle driving system (step 802). The information may be from an integrated system with the vehicle. The vehicle systems may be driving systems, GPS systems, or the like. The information may include braking frequency and speed, changing speeds, driving speeds, wandering in the lane, using turn signals, accelerating rapidly, riding the brake, following too closely, driving conditions, such as weather, construction and blockages, can be included in the information.

Next, a detector module may detect activity from a mobile device used while in a vehicle (step 804). The information received related to the vehicle driving system may include mobile information that was received while the mobile device is in use and non-mobile information that was received while the mobile device was not in use. In this description, the information is categorized as stated when “received”. However, it is noted that the information may also be categorized into mobile and non-mobile categories when the information is monitored or taken.

Next, a variance analysis module may correlate the activity with the mobile information to form a mobile driving pattern (step 806). The activity may describe networks used and network services used and the mobile driving pattern may indicate the driving pattern during use of the different networks and network services.

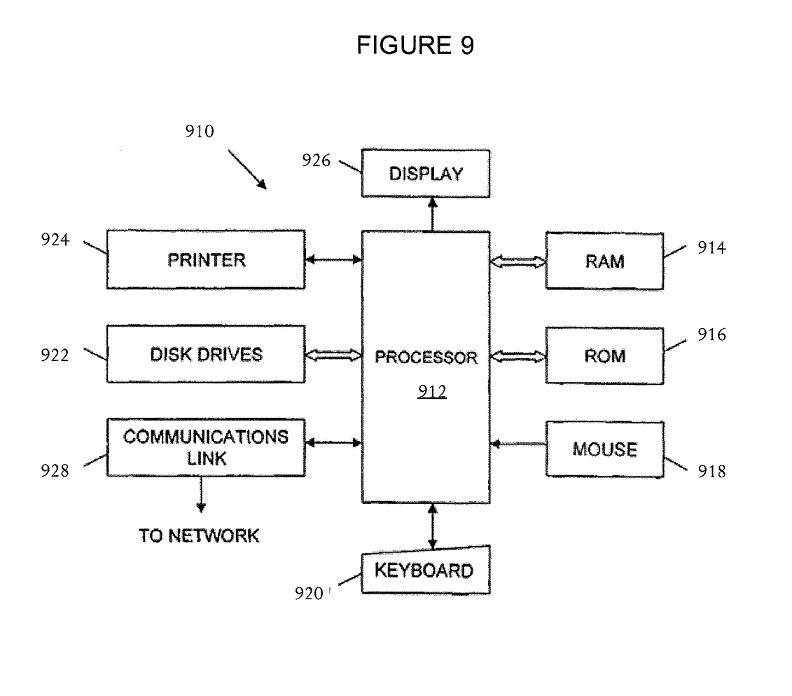

FIG. 9 is an embodiment of a general purpose computer 910—components of which that may be used in connection with other embodiments of the disclosure to carry out any of the above-referenced functions and/or serve as components for a computing device for detector module 16 of FIGS. 1-4. General-purpose computer 910 may generally be adapted to execute any of the known OS2, UNIX, Mac-OS, Linux, Android and/or Windows Operating Systems or other operating systems. The general purpose computer 910 in this embodiment includes a processor 912, a random access memory (RAM) 914, a read only memory (ROM) 916, a mouse 918, a keyboard 920 and input/output devices such as a printer 924, disk drives 922, a display 926 and a communications link 928. In other embodiments, the general purpose computer 910 may include more, less, or other component parts. Embodiments of the present disclosure may include programs that may be stored in the RAM 914, the ROM 916 or the disk drives 922 and may be executed by the processor 912 in order to carry out functions described herein. The communications link 928 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 922 may include a variety of types of storage media such as, for example, floppy disk drives, hard disk drives, CD ROM drives, DVD ROM drives, magnetic tape drives or other suitable storage media. Although this embodiment employs a plurality of disk drives 922, a single disk drive 922 may be used without departing from the scope of the disclosure.

Although FIG. 9 provides one embodiment of a computer that may be utilized with other embodiments of the disclosure, such other embodiments may additionally utilize computers other than general purpose computers as well as general purpose computers without conventional operating systems. Additionally, embodiments of the disclosure may also employ multiple general purpose computers 910 or other computers networked together in a computer network. Most commonly, multiple general purpose computers 910 or other computers may be networked through the Internet and/or in a client server network. Embodiments of the disclosure may also be used with a combination of separate computer networks each linked together by a private or a public network.

Additionally, in particular embodiments, the general purpose computers 910 computers may be mobile devices that include features such as cameras, camcorders, GPS features, and antennas for wireless communications. Mobile devices such as these include those marketed as iPhone and Android phones.

Several embodiments of the disclosure may include logic contained within a medium. In the embodiment of FIG. 9, the logic includes computer software executable on the general purpose computer 910. The medium may include the RAM 914, the ROM 916, the disk drives 922, or other mediums. In other embodiments, the logic may be contained within hardware configuration or a combination of software and hardware configurations.

The logic may also be embedded within any other suitable medium without departing from the scope of the disclosure.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a vehicle sensor monitor configured to receive information related to a vehicle driving system;
a detector module configured to detect activity from a mobile device used while in a vehicle, wherein the information comprises mobile information while the mobile device is in use and non-mobile information while the mobile device is not in use; and
a variance analysis module configured to correlate the activity with the mobile information to form a mobile driving pattern.

2. The system of claim 1, further comprising:
a central monitoring station configured to receive the non-mobile information and analyze the non-mobile information to form a historic driving pattern.

3. The system of claim 1, wherein the variance analysis module is further configured to report the mobile driving pattern to an autonomous vehicle control system to control vehicle systems in response to the mobile driving pattern.

4. The system of claim 2, wherein the detector module and the vehicle sensor monitor are configured to send the activity to the central monitoring module.

5. The system of claim 2, wherein the central monitoring module is further configured to compare the mobile driving pattern to the historic driving pattern to form a variance report.

6. The system of claim 5, wherein the variance report indicates an impaired driving ability of a driver while using the mobile device.

7. The system of claim 1, further comprising:
a video camera with infrared capability configured to detect changes in a driver eye behavior and send the changes to the vehicle sensor monitor to form the information.

8. The system of claim 1, wherein the mobile driving pattern is a driving pattern while the mobile device is in use.

9. A method for analyzing a driving pattern comprising:
receiving information related to a vehicle driving system;
detecting activity from a mobile device used while in a vehicle, wherein the information comprises mobile information while the mobile device is in use and non-mobile information while the mobile device is not in use; and
correlating the activity with the information to form a mobile driving pattern.

10. The method of claim 9, further comprising:
analyzing the non-mobile information to form a historic driving pattern.

11. The method of claim 9, further comprising:
reporting the mobile driving pattern to an autonomous vehicle control system to control vehicle systems in response to the mobile driving pattern.

12. The method of claim 10, further comprising:
sending the activity and the information to a central monitoring station.

13. The method of claim 10, further comprising:
comparing the mobile driving to the historic driving pattern to form a variance report.

14. The method of claim 13, wherein the variance report indicates a driver's impaired driving ability while using the mobile device.

15. The method of claim 9, wherein the activity indicates at least one of a network and network service.

16. An apparatus comprising:
a memory device;
a processor coupled to the memory device, wherein the processor is configured to execute instructions to perform the operations of:
receiving information related to a vehicle driving system;
detecting activity from a mobile device used while in a vehicle, wherein the information comprises mobile information while the mobile device is in use and non-mobile information while the mobile device is not in use; and
correlating the activity with the information to form a mobile driving pattern.

17. The apparatus of claim 16, the processor is configured to execute instructions to perform the operations of:
analyzing the non-mobile information to form a historic driving pattern.

18. The apparatus of claim 16, the processor is configured to execute instructions to perform the operations of:
reporting the mobile driving pattern to an autonomous vehicle control system to control vehicle systems in response to the mobile driving pattern.

19. The apparatus of claim 17, the processor is configured to execute instructions to perform the operations of:
sending the activity and the information to a central monitoring station.

20. The apparatus of claim 17, the processor is configured to execute instructions to perform the operations of:
comparing the mobile driving to the historic driving pattern to form a variance report.
